(19) United States
(12) Patent Application Publication
(10) Pub. No.: US 2006/0280087 A1
(43) Pub. Date: Dec. 14, 2006

(54) METHOD FOR RECOVERING DATA FROM OPTICAL DISC WITH DAMAGED TOC

(76) Inventors: Yen-Ying Lai, Taoyuan (TW); Yung-Chih Hsu, Taoyuan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/419,582

(22) Filed: May 22, 2006

(30) Foreign Application Priority Data
May 25, 2005 (TW) 094116992

(51) Int. Cl. G11B 7/00

(52) U.S. Cl. 369/53.24

(57) ABSTRACT

The present invention provides a method for recovering data from an optical disc with a damaged table-of-contents (TOC) zone by the use of an optical disc drive. The method is, first, to identify a latest valid TOC block from the TOC zone and to find a last known session in accordance with the latest valid TOC block. The last known session is considered as a last possible session. After judgment, if a zone for recording at least one session disc control block (SDCB) of the last possible session is full, a step is performed to detect whether a next session exists. If the next session exists, the detected next session is renewedly considered as the last possible session until the last possible session of which the zone for recording the SDCB is full is found.

### FIELD OF THE INVENTION

present invention relates to a method for recovering data; the method recovers data from an optical disc with a damaged table-of-contents (TOC) zone by the use of an optical disc drive.

### DESCRIPTION OF THE PRIOR ART

Every optical information recording medium has a zone for storing session information. For example, the session information of a DVD+R disc is stored in a table-of-contents (TOC) zone. When a DVD+R disc is mounted in a disc drive, the drive retrieves the latest TOC block from the TOC zone to obtain the session information. However, there are occasions that the latest TOC block is missing, unreadable, or incorrect. If such DVD+R disc is mounted in the disc drive, the disc drive will not be able to retrieve the information on the disc because of the incorrect session information, and the data stored in the DVD+R disc could not be retrieved although it is still complete.

To successfully retrieve the information in such discs with invalid TOC block, the present invention provides a method for recovering the data. The method is devised to search the correct session information from other storing zones of the disc; therefore, the data stored in the disc can still be retrieved by the disc drive.

### SUMMARY OF THE INVENTION

The present invention provides a method for recovering data from an optical disc with a damaged table-of-contents (TOC) zone by the use of an optical disc drive. According to a preferred embodiment of the invention, the latest valid TOC block is first identified from the TOC zone. Next, a last known session is found in accordance with the latest valid TOC block, and the last known session is then considered as the last possible session. A judging step is performed to judge if a zone for recording at least one session disc control block (SDCB) of the last possible session is full. If the zone for recording SDCB of the last possible session is full, a step is performed to detect whether a next session exists, based on the SDCB of the last possible session. If the next session exists, the detected next session is renewedly considered as the last possible session, and the foregoing judging steps are repeated until the last session is founded; in other words, the zone for recording SDCB of this last session is not full.

The method for recovering data of the invention utilizes the characteristic of the optical disc, in which the information is stored in different zones, so as to recover the invalid session information of the TOC zone. When the TOC zone is damaged, the session information can be retrieved from other storing zones of the optical disc. Therefore, the data stored in the optical disc can be retrieved, and the optical disc can be continuously used for recording.

The advantage and spirit of the invention may be understood by the following recitations together with the appended drawings.

### BRIEF DESCRIPTION OF THE APPENDED DRAWINGS

FIG. 1 is a flowchart illustrating the method for recovering data according to a preferred embodiment of the invention.

FIG. 2 is a flowchart illustrating the procedure for recording the recovery session information onto the optical disc.

### DETAILED DESCRIPTION OF THE INVENTION

The objective of the invention is to provide a method for recovering data; the method utilizes an optical disc drive to recover data from an optical disc with a damaged table-of-contents (TOC) zone.

In the method, a latest valid TOC block is first identified from the TOC zone. Next, a last known session is found in accordance with the latest valid TOC block, and the last known session is then considered as the last possible session. A judging step is performed to judge if a zone for recording at least one session disc control block (SDCB) of the last possible session is full. If the zone for recording SDCB of the last possible session is full, a step is performed to detect whether a next session exists, based on the SDCB of the last possible session. If the next session exists, the detected next session is renewedly considered as the last possible session, and the foregoing judging steps are repeated until the last session is found; in other words, the zone for recording SDCB of this last session is not full.

The invention deduces if a next session exists by judging whether the zone for recording SDCB of the session is full. That is because when the zone for recording SDCB is full, no more fragment information can be recorded in that session; therefore, that session should be closed, and a new session should be opened to allow more data to be added on the optical disc.

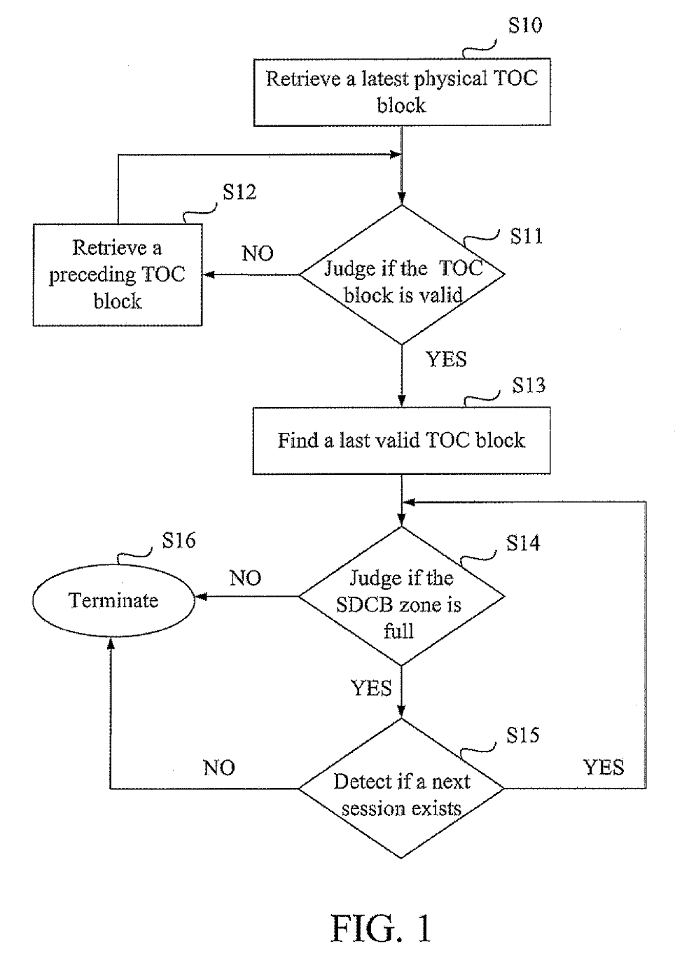

Referring to FIG. 1, FIG. 1 is a flowchart illustrating the method for recovering data according to a preferred embodiment of the invention. In this preferred embodiment, the optical disc is a DVD+R disc.

First, step S10 is performed to retrieve a latest physical TOC block from the TOC zone as a current TOC block. Afterwards, step S11 is performed to judge if the current TOC block is valid. If the current TOC block is invalid, step S12 is performed to retrieve a TOC block before the current TOC block and then to renewedly consider it as the current TOC block, and steps S11 through S12 are repeated until a valid TOC block is found. If the current TOC block is valid, step S13 is performed to consider the current TOC block as the last valid TOC block; also, a last known session is found in accordance with the latest valid TOC block, and the last known session is then considered as a last possible session. Step S14 is then performed to judge if a zone for recording at least one SDCB of the last possible session is full, and, in this embodiment, the area is the inner disc/session identification zone of the last possible session. If NO in step S14, step S16 is performed to terminate the procedure for recovering data. If YES in step S14, step S15 is then performed to detect if a next session exists, based on the SDCB of the last possible session. If the next session does not exist, step S16 is performed to terminate the procedure for recovering data. If the next session exists, the detected next session is renewedly considered as the last possible session, and steps S14 through S15 are repeated until the result of step S15 is negative.

When the optical disc drive finishes the foregoing procedure for recovering data, the completed session information can be obtained. Besides, the optical disc drive can retrieve the data stored in each session of the optical disc in accordance with the session information. The procedure for the optical disc drive to record the recovered session information onto the optical disc is illustrated as follows.

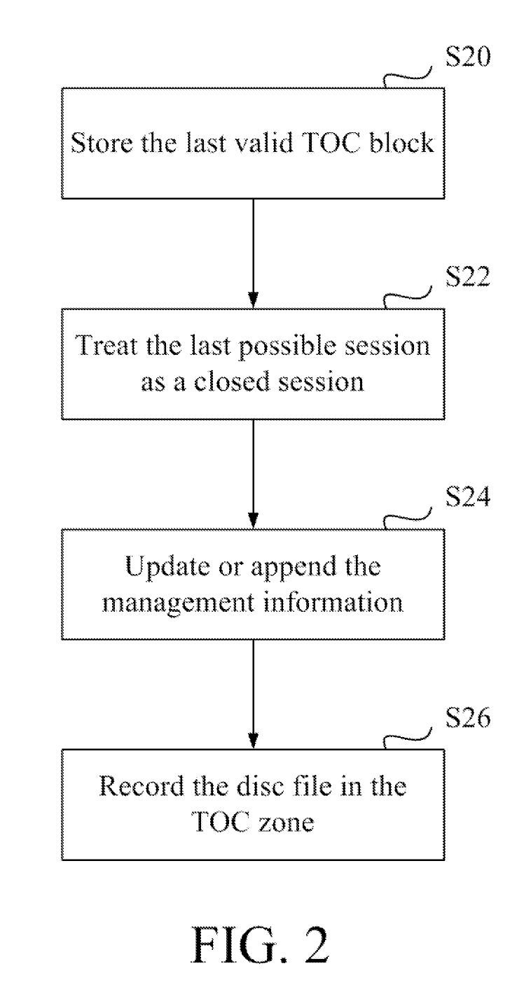

Referring to FIG. 2, FIG. 2 is a flowchart illustrating the procedure for recording the recovered session information onto the optical disc. The optical disc drive has a disc file to store the latest valid TOC block. First, when the optical disc drive detects the last valid TOC block from the TOC zone, step S20 is performed to store the last valid TOC block in the disc file. When the optical disc drive judges that the zone for recording at least one SDCB of the last possible session is full, step S22 is performed to treat the last possible session as a closed session. Step S24 is then performed to update or append the management information relative to the last possible session into the disc file in the optical disc drive in accordance with the SDCB of the last possible session. Finally, step S26 is performed. In step S26, the optical disc drive records the disc file into the TOC zone of the optical disc as a new TOC block.

The optical disc drive is also used to record new data onto the optical disc, and the management information relative to the new data can be appended into the disc file in the optical disc drive during the recording of the new data onto the optical disc. After recording the new data onto the optical disc, the optical disc drive records the disc file into the TOC zone of the optical disc as a new TOC block.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A method for recovering data from an optical disc with a damaged table-of-contents (TOC) zone by the use of an optical disc drive, said method comprising the steps of:
(a) identifying a latest valid TOC block from the TOC zone;
(b) finding a last known session in accordance with the latest valid TOC block and considering the last known session as a last possible session;
(c) judging if a zone for recording at least one session disc control block (SDCB) of the last possible session is full;
(d) if YES in step (c), detecting if a next session exists based on the SDCB of the last possible session; and
(e) if YES in step (d), renewedly considering the detected next session as the last possible session, and repeating steps (c) through (e) until the result of step (c) is NO.

2. The method of claim 1, wherein in step (a), a disc file is opened in the optical disc drive to store the latest valid TOC block.

3. The method of claim 2, wherein step (d) also performs the step of:
treating the last possible session to be closed, and updating or appending a management information relative to the last possible session into the disc file in the optical disc drive in accordance with the SDCB of the last possible session.

4. The method of claim 3, wherein the optical disc drive is capable of recording the disc file in the TOC zone of the optical disc as a new TOC block.

5. The method of claim 3, wherein the optical disc drive is used to record new data onto the optical disc, the management information relative to the new data is appended into the disc file in the optical disc drive during the recording of the new data onto the optical disc, the disc file is recorded as a new TOC block in the TOC zone of the optical disc after the recording of the new data onto the optical disc.

6. The method of claim 1, wherein step (a) is performed by the steps of:
(a1) retrieving a last physical TOC block from the TOC zone as a current TOC block;
(a2) judge if the current TOC block is valid;
(a3) if YES in step (a2), considering the current TOC block as the latest valid TOC block; and
(a4) if NO in step (a2), retrieving a TOC block before the current TOC block, renewedly considering the TOC block retrieved in step (a4) as the current TOC block, and repeating steps (a2) through (a4) until the result of step (a2) is YES.

7. The method of claim 1, wherein the optical disc is a DVD+R disc.

8. The method of claim 1, wherein the at least one SDCB of the last possible session is recorded in an inner disc/session identification zone of the last possible session.
